(19) United States
(12) Patent Application Publication
(10) Pub. No.: US 2002/0026662 A1
(43) Pub. Date: Mar. 7, 2002

(54) Removable, pressure-adjustable, shock-absorbing cushion device with an inflation pump for sports goods

(76) Inventor: Ing-Chung Huang, Kaohsiung City (CN)

Correspondence Address: JACOBSON HOLMAN PLLC, 400 SEVENTH STREET N.W., SUITE 600, WASHINGTON, DC, 20004, US

(21) Appl. No.: 09/895,312

(22) Filed: Aug. 16, 2001

Related U.S. Application Data
(63) Continuation of application No. 08/980,226, filed on Nov. 28, 1997, now Pat. No. 6,298,499.
Application No. 08/980,226 is a continuation of application No. 08/112,185, filed on Aug. 26, 1993, now abandoned.
Application No. 08/112,185 is a continuation of application No. 08/013,208, filed on Feb. 1, 1993, now abandoned.
Application No. 08/013,208 is a continuation of application No. 07/741,091, filed on Aug. 5, 1991, now abandoned.
Application No. 07/741,091 is a continuation of application No. 07/438,195, filed on Nov. 20, 1989, now abandoned.
Application No. 07/438,195 is a division of application No. 07/180,288, filed on Apr. 11, 1988, now Pat. No. 4,912,861.

(51) Int. Cl. A62B 17/00; G21F 3/02; F41H 1/00; A41D 1/00

(52) U.S. Cl. 2/455

(57) ABSTRACT

A shock absorbing cushion device removable, pressure-adjustable for sports goods, comprising a cover and an air cushion enveloped in the cover, said cushion made as a hollow flat bag whose upper and lower sheets are provided and adhered with round rcesses or line recesses or the both combined, said recesses furnishing the air cushion with shock absorbing elasticity and flexibility whether said cushion is inflated or not. An inflation pump or an air nipple is provided in said cushion for inflating or deflating said cushion.

### BACKGROUND OF THE INVENTION

1. Field of the Invention

This invention generally relates to shock-absorbers for sports equipment and, more particularly, to absorbers inflatable by a pump to an adjustable pressure.

2. Description of Related Art

Sports shoes are generally provided with tongues which are provided with a thin layer of sponge. The shock-absorbing function of the thin sponge layer is not ideal during use, because the user not only feels pressure against his foot, but also discomfort owing to the lace binding, the foot being full of blood vessels and sinews. When a foot stops during exercise, the shock forces against the shoe manly fall on the tongue and the lace section in addition to the toe box. The thin sponge layer of the tongue cannot endure such-shock forces against the foot.

It would be desirable to make a shoe tongue that could endure such shock forces, could be provided with different shock-absorbing capabilities to cope with both walking and exercising, and could be comfortable without pressing the foot.

There is a kind of hard skiing shoe provided with air-inflated shoe tongues, each made of two pieces stuck together and forming an empty pocket if the air should leak out owing to breakage or wear and tear. Once the tongues- become flat, they can hardly be repaired. The entire skiing shoes have to be discarded. This is wasteful and uneconomical.

### SUMMARY OF THE INVENTION

The inventor, after practical study and experiments, has worked out a shock-absorbing cushion device for shoe tongues which can be removed, changed to a new one, and is adjustable in its internal pressure by use of an inflation pump. The device is able to be used in sports shoes, boots, knee protectors, and other sports goods.

### Objects of the Invention

The objects of this invention are set forth below:

1. To furnish a kind of shock-absorbing cushion device whose inflation pressure is adjustable as desired, thereby selecting the degree of elastic absorption.

2. To furnish-a kind of shock-absorbing cushion device that can maintain the original shock-absorbing space and function, without becoming flat even if the device was damaged or was not inflated.

3. To furnish a kind of shock-absorbing cushion device that can be adjusted in its internal pressure such that the sports goods may have tight contact with a part of the body to be protected and the capability of absorbing shock.

4. To furnish a kind of shock-absorbing cushion device that can be inflated or deflated according to different necessity while in use

5. To furnish a kind of shock-absorbing cushion device that is waterproof and does not separate.

6. To furnish a kind of shock-absorbing cushion device that can absorb unbalanced shock forces, change them into a balanced shock force, and remove foot pressure and discomfort.

7. To furnish a kind of shock-absorbing cushion device that can easily be fixed on or taken off a sports goods.

To 8. furnish a kind of shock-absorbing cushion device that can be used in a shoe tongue to prevent the shoe lace from becoming loose, tight, unbalanced or unstable.

9. To furnish a kind of shock-absorbing cushion device that can be used in a shoe tongue to make feet comfortable by inflating said tongue to a proper pressure when a user puts on the shoes, and can enable the shoes to be taken off easily by deflating the air inside.

### Features of the Invention

This shock-absorbing cushion device is removable and pressure-adjustable and is used in sports goods. The device comprises a cover and an air cushion enveloped in the cover. By means of blow shaping, the air cushion is shaped as a hollow bag made up of two sheets of polyethylene or an analogous material. The two sheets, an upper and a lower, are provided with vertical round recesses or vertical linear recesses extending crosswise or lengthwise of the cushion. The sheets are adhered together at the recesses. The recesses enable the air cushion to have shock absorbing elasticity and flexibility. The recesses maintain the flatness of the outer surface of the cushion whether the air cushion is inflated or not, in order to cope with the bending movement of a part of a human body. The air cushion can be provided with an inflation pump or an air nipple for inflating or deflating the cushion.

The air cushion combined together with the cover can be fixed on a ports goods such as sports shoes, knee protectors, shoulder protectors, etc., by means of shoe laces, snap fasteners, sticker fasteners, etc.

### BRIEF DESCRIPTION OF THE DRAWINGS

FIG. 1 is a perspective view of the removable pressure adjustable shoe tongue with an inflation pump in accordance with the present invention,

FIG. 2 is a cross sectional view of the 3 inflation pump in the shoe tongue in accordance with the present invention,

FIG. 3 is an operational view of the inflation pump and the air cushion inside the shoe tongue in accordance with the present invention,

FIG. 4 is an operational view of the inflation pump under deflating action in accordance with the present invention,

FIG. 5 is a cross sectional view of the air nipple set on the shoe tongue in accordance with the present invention,

FIG. 6 is a top plan view of ah embodiment of an air cushion inside the shoe tongue in accordance with the present invention,

FIG. 6-1 is a cross sectional view taken on line 6-1-6-1 of FIG. 6,

FIG. 6-2 is a cross sectional view taken on line 6-2-6-2 of FIG. 6,

FIG. 7 is a top plan view of another embodiment of an air cushion inside the shoe tongue used for boots in accordance with the present invention,

FIG. 7-1 is a cross sectional view taken on line 7-1-7-1 of FIG. 7,

FIG. 7-2 is a cross sectional vie taken on line 7-2 of FIG. 7,

FIG. 8 is a top plan view of still another embodiment of an air cushion in the shoe tongue in accordance with the present invention,

FIG. 8-1 is a cross sectional view taken on line 8-1-8-1 of FIG. 8,

FIG. 8-2 is a cross sectional view taken on line 8-2-8-2 of FIG. 8,

FIG. 9 is a top plan view of an additional embodiment of an air cushion in the shoe tongue used in boots in accordance with the present invention,

FIG. 9-1 is a cross sectional view taken on line 9-1-9-1 of FIG. 9,

FIG. 9-2 is a cross sectional view taken on line 9-2-9-2 of FIG. 9,

FIG. 10 is a top plan view of still another embodiment of an air cushion in the shoe tongue in accordance with the present invention,

FIG. 10-1 is a cross sectional view taken on line 10-1-10-1 of FIG. 10,

FIG. 11 is a top plan view of another embodiment of an air cushion in the shoe tongue used for boots in accordance with the present invention,

FIG. 11-1 is a cross sectional view taken on line 1-1-11-1 Of FIG. 11,

FIG. 12 is a top plan view of another embodiment of an air cushion in the shoe tongue in accordance with the present invention,

FIG. 12-1 is a cross sectional view taken on line 12-1-12-1 of FIG. 12,

FIG. 13 is a top plan view of another embodiment of an air cushion in the shoe tongue used for boots in accordance with the present invention,

FIG. 13-1 is a cross sectional view taken on line 13-1-13-1 of FIG. 13,

FIG. 14 is a top plan view of another embodiment of an air cushion inside the shoe tongue in accordance with the present invention,

FIG. 14-1 is a cross sectional view taken on line 14-1-14-1 of FIG. 14,

FIG. 15 is a top plan view of another embodiment of an air cushion inside the shoe tongue in accordance with the present invention,

FIG. 15-1 is a cross sectional view taken on line 15-1-15-1 of FIG. 15,

FIG. 16 is a top plan view of another embodiment of an air cushion inside the shoe tongue in accordance with the present invention,

FIG. 16-1 is a cross Sectional view taken on line 16-1-16-1 of FIG. 16,

FIG. 17 is an enlarged cross sectional view of an air cushion combined with an air nipple in accordance with the present invention,

FIG. 18 is a perspective view of a shoe counter with the shock absorbing cushion device shown in a shoe illustrated in phantom lines in accordance with the present invention,

FIG. 19 is a perspective view of a knee protector with this shock absorbing cushion device in accordance with the present invention,

FIG. 20 is a top plan view of another embodiment of a shoe counter with the shock absorbing cushion device in accordance with the present invention, and

FIG. 21 is a top plan view of another embodiment of a shoe counter with the shock absorbing cushion device in accordance with the present invention.

### DETAILED DESCRIPTION OF THE PREFERRED EMBODIMENTS

The removable, pressure adjustable, shock-absorbing cushion device in accordance with the present invention, as applied to a shoe tongue, is shown in Fig. 1. The shoe tongue comprises a cover 1 and an air cushion 2. The cover 1 is made of cloth, leather or any other fiber, and contains and keeps the air cushion 2 inside the cover. The cover is provided with several eyelets 11 at its front for a shoe lace to penetrate and a hole 12 at its rear edge. An inflation pump 21 or an air nipple 23 extends through the hole 12. A bag 13 envelopes the inflation pump 21 when the pump is not in use. The cover 1 can be combined with the shoe by means of the eyelets 11 or analogous fasteners such as a zipper, snap fasteners, sticker fasteners, or buttons, etch

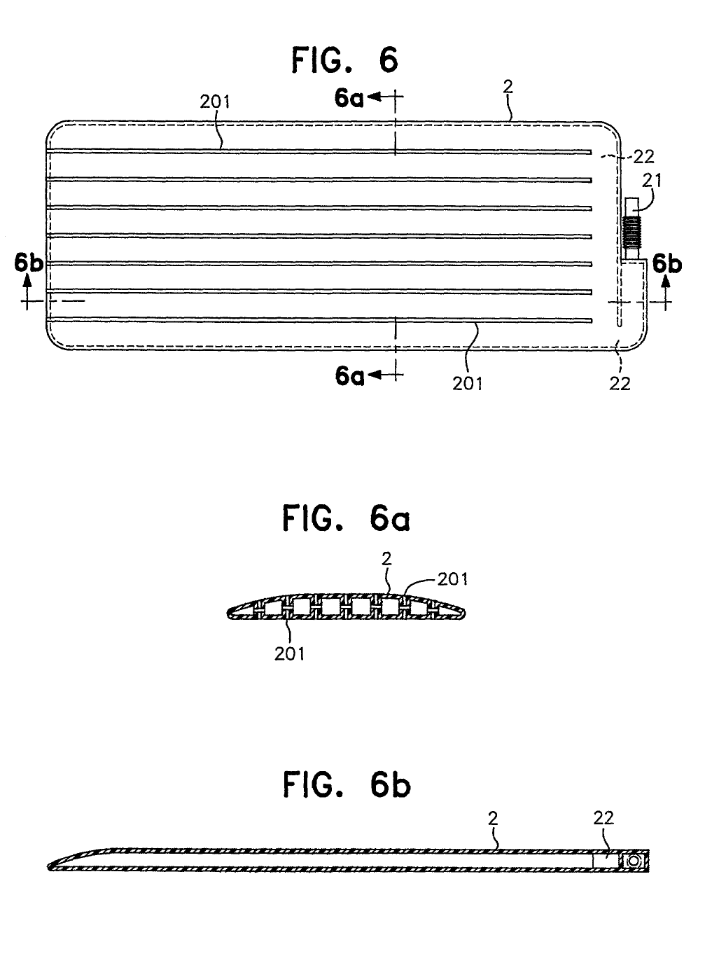

The air cushion 2 can be made of polyethylene, ethylene, or any other material with excellent elasticity, flexibility, extensibility and durability against low temperature, and that is easy to shape by blowing techniques. The air cushion 2 is provided with a plurality of round recesses or linear recesses on its upper and lower sheets. The bottoms of the recesses 201 (see FIG. 6) on both sheets are adhered together so that the vertical cross section of each recess has a square shape.

The arrangement of round and recesses can be changed in many ways but they have to be located so as to balance in the lengthwise and crosswise directions. The vertical sustaining force and the elasticity that both vertical side walls of round recesses or linear recesses produce make up effectively the sustaining force of the whole hollow air cushion. This shock-absorbing cushion device design provides an excellent outer surface flatness and a strong interactive sustaining function and prevents possible deformation due to high pressures. Of importance is that the air cushion 2 itself can never be totally flattened because of the vertical square cross section of the round or linear recesses even if the cushion is damaged or not yet inflated.

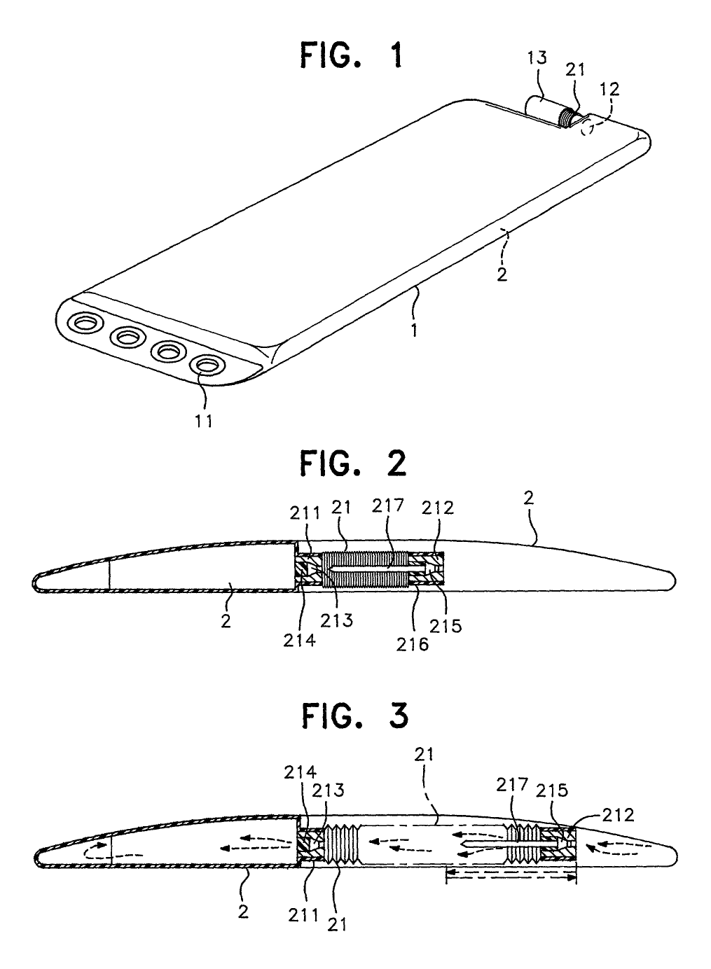

As shown in FIGS. 2, 3 and 4, the rear end of the inflation pump 21 is fixed steadfast with the air cushion as one unit. The pump 21 is an elastic tube that can be expanded or contracted to draw in air through a one way valve 215 set in a valve base 212 at the front. Another one way valve 213 set in a valve base 211 at the rear cooperates with the valve 215 to draw in the airs sponges 214, 216 surround the valves 213, 215, giving them auxiliary force for stabilizing the position of said valves 213, 215 when they return to their original positions. The sponges also filter the air drawn in. In addition, a bar 217 extends backward from the valve 215, penetrates through the sponge 216 and reaches to the middle of the elastic tube of the pump 21. The bar 217 does not touch the rear of the valve 213 in the original position, but can be pushed back by the valve 215 to push the valve 213 if a little bar 24 is inserted into the front of the inflation pump 21 pushing back the valve 215, whereupon both valves 213, 215 are opened to release the air inside the air cushion 2.

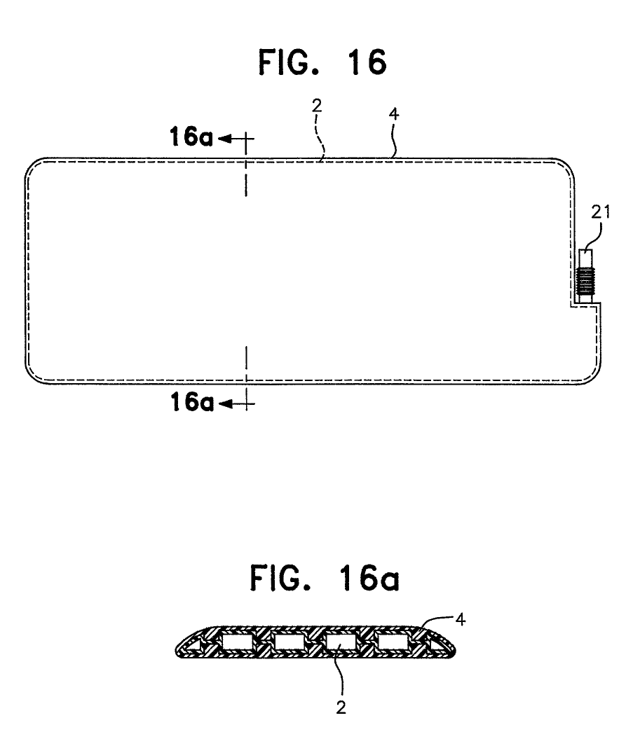

The inflation pump 21 can be replaced by an air nipple 23 made of rubber. A needle is inserted into the nipple to inflate or deflate the air cushion 2. The air nipple 23 has several outward protrusions 230 at its end which is set in a round tube 202. The protrusions prevent the nipple from falling off said tube 202. The tube 202 is tightly bound around by several rubber bands 231 to prevent the air nipple from falling off at the same time. The main function of the rubber bands is to prevent the air cushion 2 from exploding open if the cushion 2 should receive a shock force larger than it can endure. Such a shock force greater than the binding force of the rubber bands would produce a gap between the air nipple 23 and the tube 202, thereby causing the air inside the cushion 2 to escape through the gap. As FIG. 17 shows, the outer circumference of the tube 202 can be shaped as a thread and the cross section of the thread may be triangular, square, semicircular, oblong or any shape, provided that the air nipple 23, after set in the tube 202, can strongly resist the escape of air.

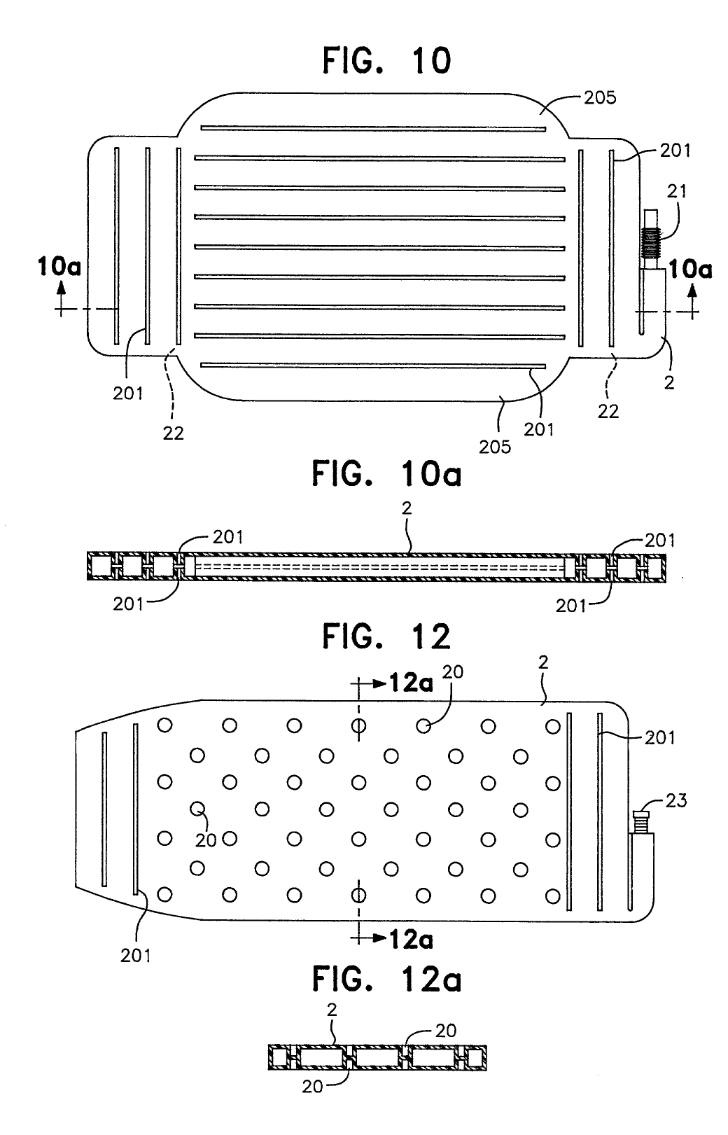

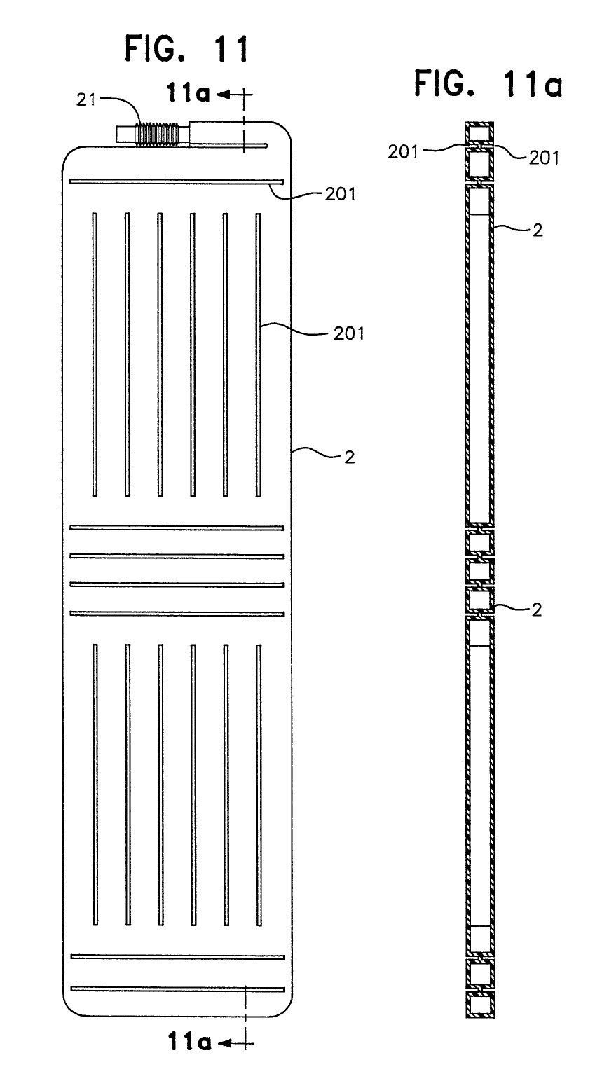

Next, examples of air cushions provided with round recesses 20 (see FIGS. 12) and linear recesses 201, either separately or in combination, are described with reference to the Figures.

FIGS. 6, 6-1, 6-2 show a kind of air cushion 2 provided with lengthwise linear recesses 201, but one end of every linear recess 201 is not connected with a circumferential edge of the cushion so that air can circulate through a passage formed between the circumferential edge and the ends of the linear recesses 201. The upper and lower sheets of the cushion 2 have a flat surface and the cross section of the air space inside the cushion 2 is shaped as a square. The cushion is inclined at its peripheral edges according to the inclined upper surface of the foot.

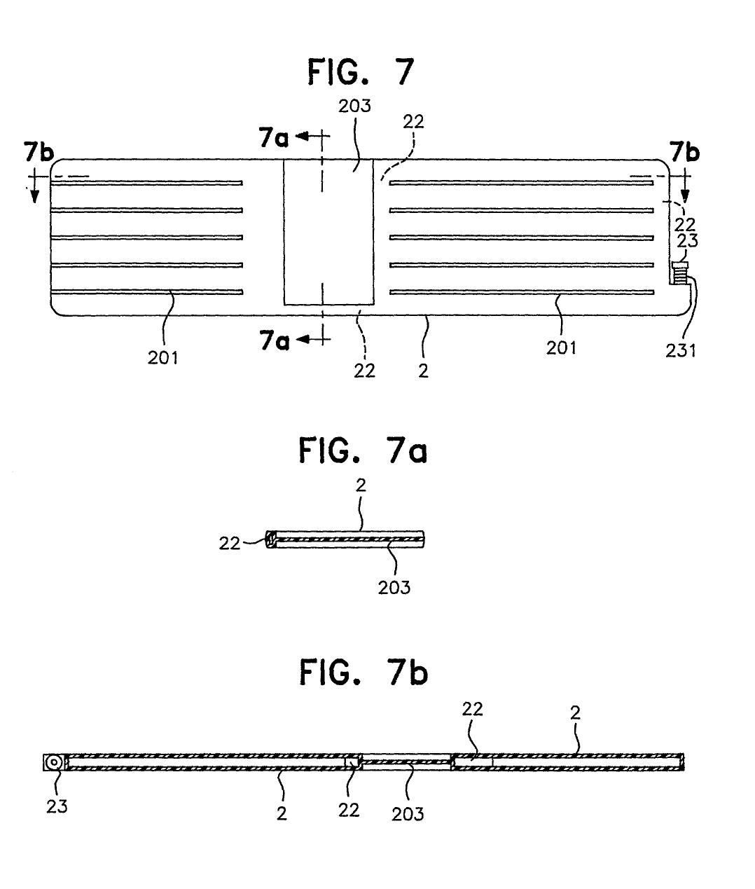

FIGS. 7, 7-1, 7-2 show an example of an air cushion used for a boot with a little change added to the example shown in FIG. 6. This cushion is provided with a square flat section 203. Between the inside ends of the linear recesses 201 on both sides of said section 203 is separately set a passage for the air inside to pass through. The outside ends of said recesses 201 are either connected or not connected with a respective circumferential edge. The embodiment of FIGS. 7 is provided with an air nipple 23.

FIGS. 8, 8-1, 8-2 show an example of an a cushion 2 with crosswise linear recesses 201 connected with a circumferential edge of the cushion at both ends thereby dividing the inside space into a plurality of crosswise independent rooms. Short tubes 204 of smaller diameter than the height of the air cushion are set across the recesses 201 for the air in each independent room to pass through. Therefore, this cushion can acquire good crosswise flexibility owing to the crosswise recesses 201. The comparatively small tubes 204 never hamper the cushion from bending. The tubes 201 are not easily broken. The vertical cross-section of the linear recesses resembles a square.

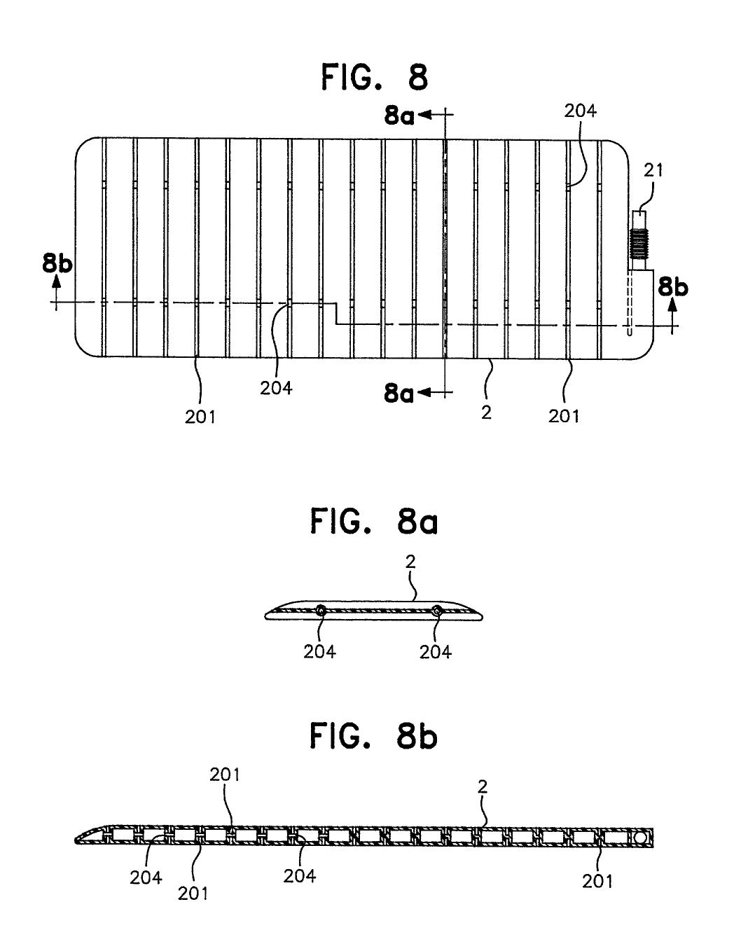

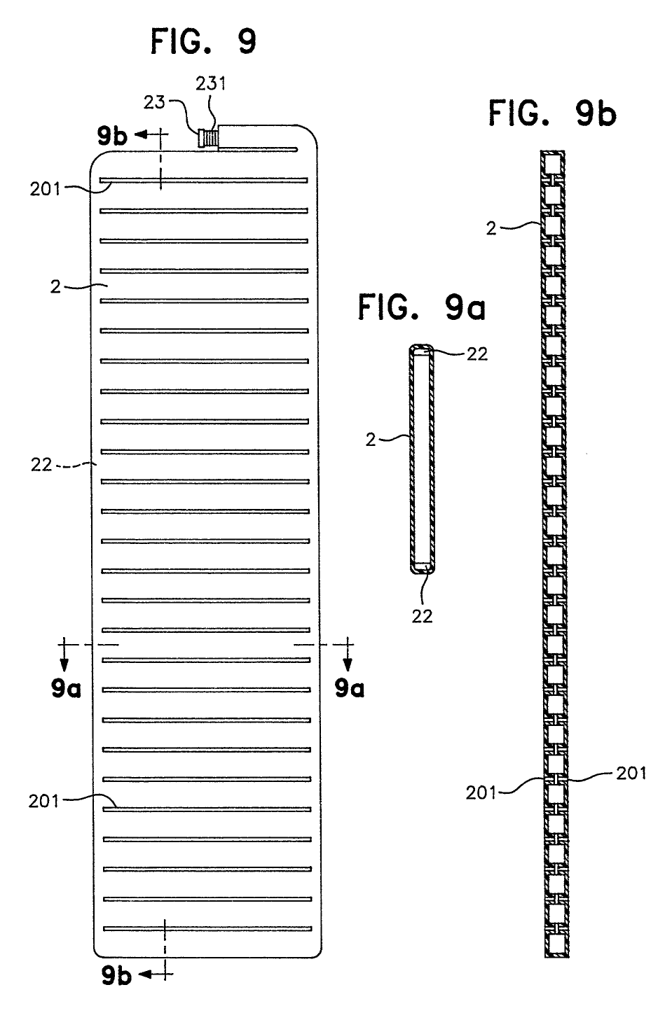

FIGS. 9, 9-1, 9-2 show an example of an air cushion used for a boot with the crosswise linear recesses 201 of FIG. 8 changed a little. Both ends of the linear recesses 201 do not connect with the circumferential edges such that passages are formed between the ends of said recesses 201 and said edges. This cushion 2 can be bent crosswise and can be provided with an air nipple 23 or an inflation pump 21.

FIGS. 10, 10-1 show an example of air cushion 2 with crosswise and lengthwise linear recesses 201 combined at the same time. The ends of the crosswise or lengthwise linear recesses 201 are not connected with any circumferential edge. The crosswise linear recesses 201 do not meet the lengthwise linear recesses 201 so that passages 22 are formed around the circumferential edge. The cross section of the inside of the cushion still is square shaped, in spite of the crosswise and lengthwise linear recesses 201. An air nipple 23 or an inflation pump 21 can be provided with this cushion. This cushion is provided with extending out wings 205 to make it broader to cover the foot.

FIGS. 11, 11-1 show an example of an air cushion used for boots quite similar to the example shown in FIG. 10.

FIGS. 12, 12-1 show an example of an air cushion 2 provided with many round recesses 20 and a few crosswise linear recesses 201 and an air nipple 23. The round recesses 20 and the linear recesses 201 have the illustrated cross section. This cushion has its inside hollow spaces in mutual communication, except for the places where the round recesses 20 and the linear recesses 201 are located. This kind of cushion can also be made with a little wider front part to cover the eyelets 11 of the cover 1 in order to widely cover the foot.

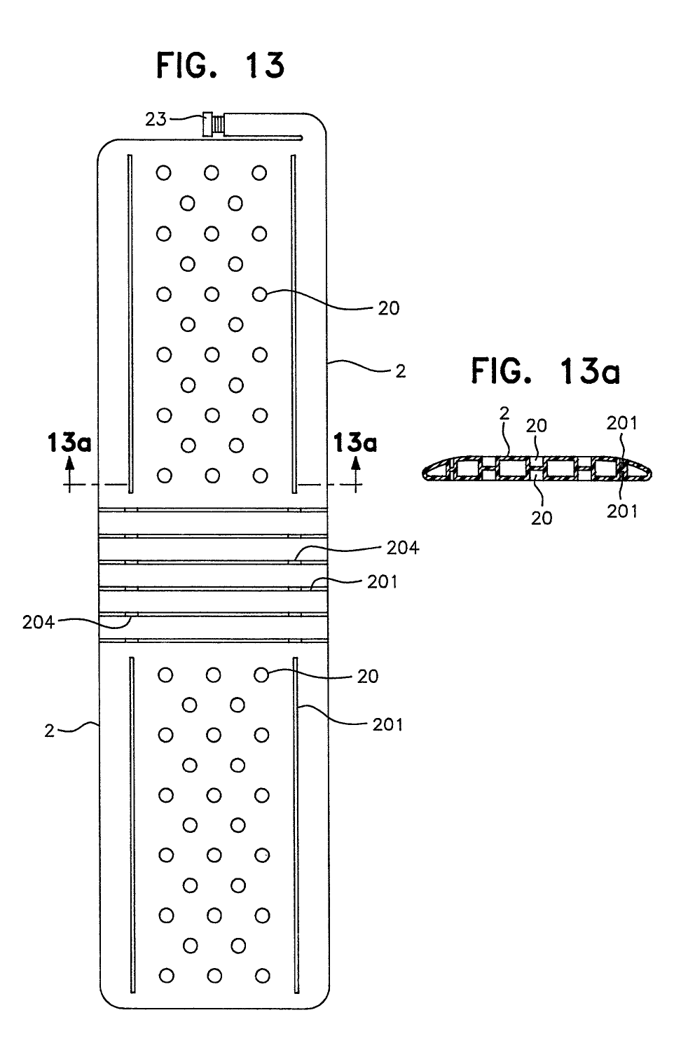

FIGS. 13, 13 1 show an example of an air cushion provided with a combination of round recesses 20 and crosswise and lengthwise linear recesses 201. Both ends of the lengthwise linear recesses 201 do not connect with any circumferential edge for forming passages 22. However, the crosswise linear recesses 201 are connected with both circumferential edges and are provided with short tubes 204 set across them as shown in FIG. 8 for the air inside to pass through in order that this cushion may have a crosswise bending capability to cope with the inclined upper face of the foot. Either an air nipple 23 or an inflation pump 21 can be provided in this cushion 2.

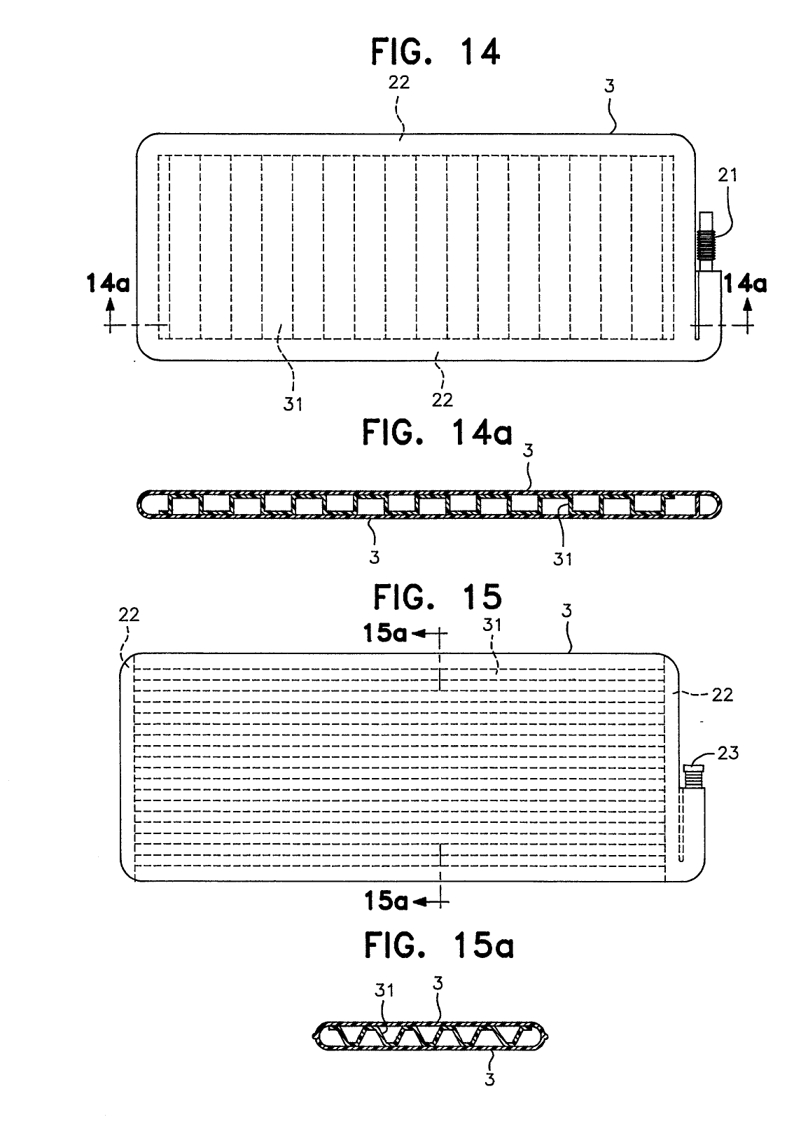

Figs. 14, 14-1 show an example of an air cushion 3, wherein a continuous, bent middle sheet 31 adheres to the upper and the lower sheets intermittently at spaced locations. The middle sheet 31 has a narrower width than that of the air cushion 3 such that passages 22 are formed by means of the difference of their widths. This kind of air cushion can have flatter surfaces than the others.

FIGS. 15, 15-1 show an example of an air cushion quite similar to the example of FIG. 14. The difference between them consists in the shape of the middle sheet 31 set between the upper and the lower sheets. This middle sheet 31 has a continuously bent slope and also is adhered to the upper and the lower sheets intermittently at spaced locations. This cushion can also have flatter surfaces than the others

The air cushion used in a shoe tongue can also be made by means of heat sealing as shown in FIGS. 16, 16-1. A layer of foam material has to be added on the surface of this cushion to make it flat as this cushion made through heat sealing can have a rather rough surface.

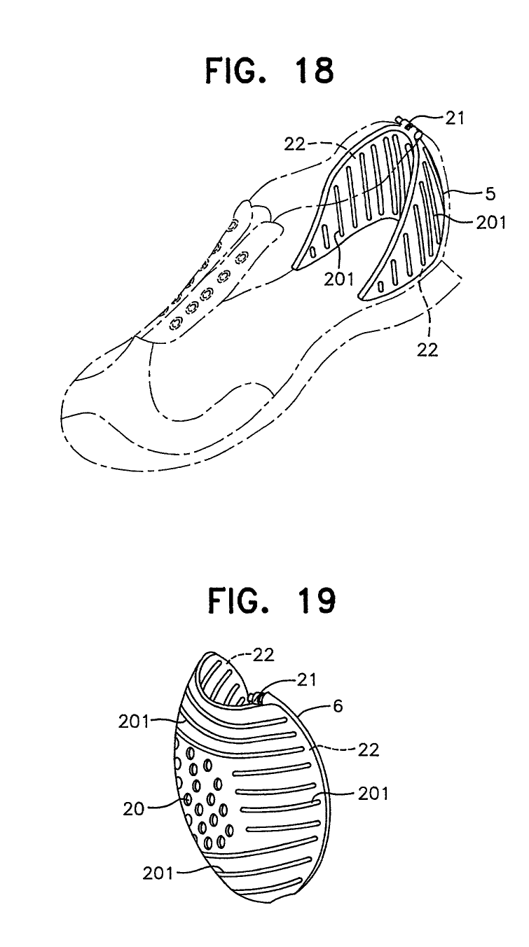

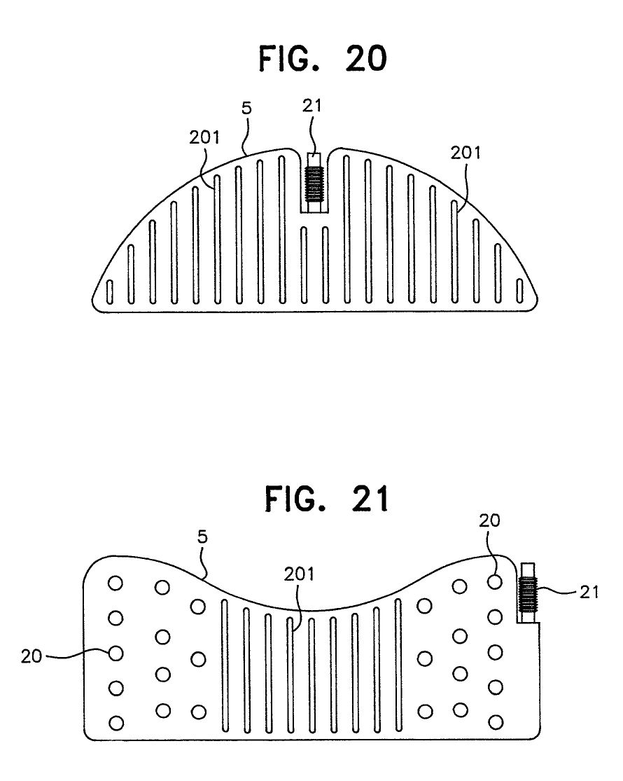

FIGS. 18, 20, 21 show a shoe counter cushion 5 provided with this shock absorbing cushion device for a sports shoe. The counter cushion 5 comprises crosswise linear recesses 201 adhering the upper sheet to the lower sheet. The hollow width of said linear recesses 201 allows the cushion 5 to conform to the vertical face of the heel to absorb shock. An inflation pump 21 or an air nipple 23 can be used in this device.

FIG. 19 shows a kind of knee protector which comprises an air cushion 6 in accordance with the present invention. The cushion 6 is provided with crosswise linear recesses 201 on the upper and the lower sheets. The height of the recesses 201 serves as bending space for the knee, ensuring the function of protecting the knee from being hurt but not hampering the movement of the knee. This cushion 6 can be provided with an inflation pump 21 or an air nipple 23.

Of course, this shock-absorbing structure can not only be applied to a shoe tongue, a counter cushion for sports shoes and a knee protector as described above, but also to a shoulder protector, or any other sports goods.

After an air cushion 2 is sealed in a cover 1, both of them make up a shock absorbing structure removable, pressure adjustable and ready to be used in sports shoes.

To inflate air into the air cushion 2, the inflation pump 21 is expanded or pulled lengthwise as shown in FIG. 3. As the pump 21 is pulled long and extended, a vacuum condition is produced inside the pump 21, thereby sucking air into the open one-way valve 215 at the front of the pump 21. When the pump 21 is pushed short and retracted instead of expanded, the air drawn inside is compressed to close the valve 215 and to push open the one way valve 213 at the same time so that the air is pushed and flows into the air cushion 2. Repeating these actions to expand and to contract the pump 21 inflates the cushion 2 to the extent desired.

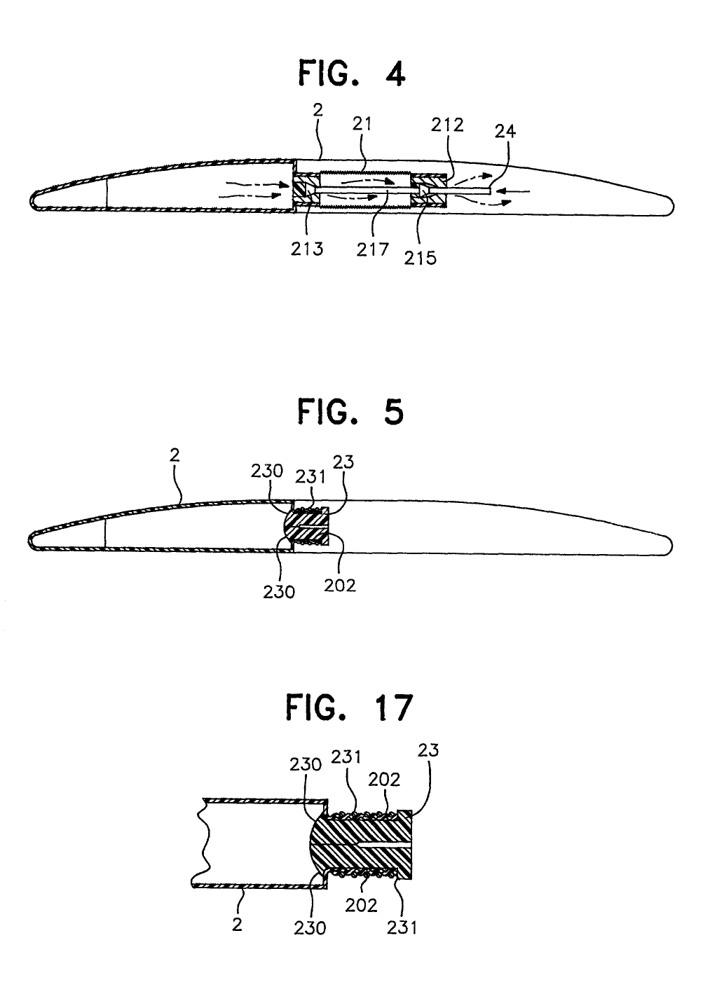

On the contrary, to deflate or decrease the inside pressure of the air cushion 2, the valve 215 should be pushed open backward to make the bar 217 push the valve 213 open so that the air inside the cushion can be expelled out to the extent desired as shown in FIG. 4.

In general, this shock-absorbing cushion device in accordance with the present invention not only has a special practical usefulness, but also is effective in preventing injuries during exercise or playing a sport. In addition, its special features are removability, adjustability in its pressure and the excellent elasticity against shock even if it is not inflated.

The interior of the air cushion can be filled with air, foamed polyurethane, water, oil, or any fluid of low percolation.

What is claimed is:

1. A removable, pressure-adjustable shock-absorbing cushion device with an inflation pump for sports goods comprising;
an air cushion made up of an upper and a lower sheets provided with a plurality of round recesses or line recesses, said round and line recesses on said sheets having a vertical cross section and the bottoms of said recesses adhered together to keep the surfaces of said air cushion flat and the interior hollow space of said air cushion to maintain its original shape even if said air cushion is broken or not inflated and or to give shock-absorbing elasticity to said cushion;
an inflation pump being provided partly inside said air pump and its front extending out a cover enveloping said air cushion, said pump comprising a hollow tube whose middle section can be expanded or contracted like bellows to draw in or expel air out, both ends of said tube separately fixed with a one-way valve, one of said one-way valve drawing in airi and the other expelling out air; and
a cover enlevoping said air cushion and provided with a hole for the front of said inflation pump or an air nipple to extend out, said cover combined with said air cushion provided with said inflation pump making up a unit removable and pressure-adjustable able to be used in sports goods such as sports shoes, knee protectors, ect.

2. The removable, pressure-adjustable shock-absorbing cushion device for sports goods as claimed in claim 1, wherein said cover is made of cloth, leather, or fiber.

3. The removable, pressure-adjustable shock-absorbing cushion device for sports goods as claimed in claim 1, wherein said cover is at its front provided with several eyelets for a shoe lace to go through and a hole for the front of an inflation pump set in said air cushion to extend and preferably at its rear end.

4. The removable, pressure-adjustable shock-absorbing cushion device for sports goods as claimed in claim 1, wherein said inflation pump comprises a middle tubal section expansible and contractible, the rear end of said pump connected, with a one-way valve only drawing air into said air cushion, the front end of said pump connected with a one-way valve only drawing air outside into said pump.

5. The removable, pressure-adjustable shock-absorbing cushion device for sports goods as claimed in claims 1 and 4, wherein said oneway valves are separately set in a base, and a bar is set connected with said one-way valve at the front of said pump and extending backward, said bar being possible to be pushed backward by pudhing said one-way valve to force the one-way valve at the rear end of said pump to retreat so that both of said valves can simultaneously be made open to deflate said air cushion.

6. A kind our air cushion comprising a removable, pressure-adjustable shock-absorbing cushion device with an inflation pump for sports goods, wherein the upper and the lower sheets of said air cushion are provided with a plularity of round recesses and adhered together with said round recesses, the cross-section of said said round recesses being shaped as vertical square, and the cross section of two round recesses abutting each other being shaped as hollow square.

7. The air cushion comprising a removable, pressure-adjustable shock-absorbing cushion device with an inflation pump for sports goods as claimed in claim 6, wherein the upper and the lower sheets of said air cushion can also be provided with a plurality of crosswise line recesses and adhered together with said line recesses, the width of each line recesses serving as the expansible and contractible space to furnish said air cushion with good crosswise flexibility, the cross section of said line recesses being inwardly recessing squarre, the cross section of the air cushion between two line recesses being hollow square, and at least one end of each line recess not connecting with the circumferential edge so that a passage can be formed between said ends of said line recesses and the circumferential edge for the air inside said air cushion to pass through.

8. The air cushion as claimed in claim 7, wherein said crosswise line recesses can be made to connect with the circumferential edge at both ends, at least a hollow tube smaller than the height of said air cushion having to be fixed across each line recess for the air to pass through.

9. The air cushion as claimed in claim 6, wherein said upper and lower sheets of said air cushion can be provided with lengthwise line recesses, the cross section of each line recess being shaped as inwardly recessing square, the cross section of said air cushion between two line recesses being shaped as hollow square, and said lengthwise line recesses furnishing said air cushion with good lengthwise flexibility.

10. The air cushion as claimed in claim 9, wherein at least one end of every lengthwise line recess does not connect with the circumferential edge to form an air-flowing passage inside said air cushion.

11. The air cushion as claimed in claim 9, wherein every lengthwise line recess can connect with the circumferential edge at both ends, at least a tube smaller than the height of said air cushion having to be set across each line recess for the air to pass through.

12. The air cushion as claimed in claim 6, wherein the upper and the lower sheets of said air cushion can be provided with a combination of round recesses and line recesses, said line recesses being able to be made crosswise or lengthwise.

13. A kind of air cushion compressing a removable, pressure-adjustable, shock-absorbing cushion device for sports goods, wherein the upper and the lower sheets of said air cushion can be sustained with a middle sheet of a corrugated cross section set between them, the upper peaks and the lower peaks of said middle sheet separately adhered with the upper and the lower sheets for said air cushion to maintain the flatness of the upper and lower surfaces.

14. The air cushion as claimed in claim 13, wherein the middle sheet set between the upper and the lower sheets can be shaped corrugated as waves, square, saw teeth or any form.

15. The air cushion as claimed in claim 13, wherein the middle sheet is continuously bended squarely up and down between the upper and the lower sheets, and adhered with said both sheets by heat sealing.

16. The air cushion as claimed in claims 1, 6, 7, 9, 12, 13, wherein the interior of the air cushion can be filled with air, foamed polyurethane, water, oil or any fluid of low percolation.

17. The air cushion as claimed in claims 1, 6, 7, 9, 12. 13, wherein said air cushion can be shaped as a long strip with the front narrow and the rear broad.

18. The air cushion as claimed in claims 1 6, 7, 9, 12, 13, wherein said air cushion can be shaped Raider at the middle section than at the rear section.

19. The air cushion as claimed in claims 1, 6, 7, 9, 12, 13, wherein crosswise line recesses can be provided to furnish said air cushion with crosswise flexibility and spaces

20. The air cushion as claimed in claims 1, 6, 7, 9, 12, 13, wherein said air cushion can be shaped as any form with hollow space and flat upper and lower surfaces.

21. The air cushion as claimed in claims 1, 6, 7, 9, 12, 13, wherein said inflation pump can be taken place by an air nipple made of rubber,said air nipple being inserted in a hollow tube set communicable with the interior of said air cushion, said air nipple provided with several protrusions at its rear end for hooking the end edge of said tube, at least one rubber band binding around the outer surface of said tube with said air nipple inserted therein, and said rubber band having good elasticity.

22. The air cushion as claimed in claims 1, 6, 7, 9, 12, 13, 21, wherein said hollow tube for said air nipple to be inserted in can be provided with continuous threads around its outer face, the cross section of said threads being triangular, square, semicircular, oblong or of any form such that said tube inserted with said air nipple can have an excellent function in preventing air from percolating in.

23. The air cushion as claimed in claims 1, 6, 7, 9, 12, 13, wherein said corer can be combined with shoes with eyelets, a zipper, a sticker fastener a snap fastener, a button, etc.

24. The air cushion as claimed in claims 1, 6, 7, 9, 12, 13, 22, wherein said air cushion can be coated with foaming material on the upper face to make it flat.
